(19) United States
(12) Patent Application Publication
(10) Pub. No.: US 2003/0046224 A1
(43) Pub. Date: Mar. 6, 2003

(54) Method and apparatus for handling monetary transactions

(76) Inventors: M. Shahid Mujtaba, Milpitas, CA (US); Cipriano A. Santos, Riverbank, CA (US); Beatriz Escobar-Mujtaba, Milpitas, CA (US)

Correspondence Address: HEWLETT-PACKARD COMPANY, Intellectual Property Administration, P.O. Box 272400, Fort Collins, CO, 80527-2400, US

(21) Appl. No.: 09/944,312

(22) Filed: Aug. 30, 2001

(51) Int. Cl. G06F 17/60

(52) U.S. Cl. 705/39

(57) ABSTRACT

A process for facilitating financial transactions between individuals residing in different locations. Independent sender agents and independent receiver agents handle the transactions, working through an intermediary and one or more financial institutions. An intermediary is established to function as a clearing house, guarantor, auctioneer, and/or tracker of the transaction. Information regarding the transactions are sent through a data network, such as via telephone or the Internet. The funds are sent through one or more financial mediums, such as by bank wires, ATM cards, smart cards, store credits, or similar financial vehicles. Thereby, the process functions to provide fast, safe, and economical monetary remittances.

### TECHNICAL FIELD

The present invention pertains to an apparatus and method for facilitating monetary transactions between parties at different geographical locations.

### BACKGROUND ART

Many individuals and small businesses today transfer money to distant relatives, friends, other businesses, etc. located a geographical distance away from the sender. FIG. 1 shows a typical scenario whereby a sender 101 desiring to send money first approaches a financial intermediary 102 who, through its paid agents and infrastructure, performs the actual monetary transaction to deliver the money to a receiver 103. Examples of financial intermediaries include bank wires, international money orders, bank drafts or postal money orders. In addition, private companies (e.g., Western Union) specialize in the express purpose of facilitating these types of monetary transactions.

Each day, huge sums of money are sent through these traditional financial channels. Unfortunately, these traditional means of handling monetary transactions fall short when the receivers of such transactions live in small, rural, or remote communities. From a global perspective, many people live outside the major metropolitan areas. As such, there are several obstacles encountered when using traditional means for transferring money to such receivers.

One huge disadvantage of bank wires is that they carry significant fees. Given that many of such transfers are for relatively small amounts of money, the imposed fees may constitute a rather hefty percentage of the total amount being sent. Another major disadvantage is that there must be a financial site in both the originating and destination locations. As stated above, this is impractical for those instances where either the sender and/or receiver cannot readily travel to the closest site. Furthermore, banks only accept wire transfers from those who already have an established banking relationship with that particular institution or are otherwise creditworthy. Typically, wire transfers involve taking money from one account and transferring that money to a different account. In many instances, the sender or receiver lack the requisite credentials or degree of sophistication to set up accounts and to initiate a bank wire.

Other forms of monetary transfers include International money orders, bank drafts and postal money orders. Unfortunately, these types of monetary transfers are quite slow because they must be delivered by mail. Furthermore, postal services are notoriously unreliable. These problems are exacerbated when the International money orders, bank drafts, or postal money orders are to be sent internationally and must traverse several different postal service systems. In addition, the International money orders, bank drafts, or postal money orders impose costly transaction and exchange rate commissions. And they must be negotiated with a financial institution with whom the sender or receiver has a banking relationship at the receiving end.

In light of these problems, some private businesses have been set up for the express purpose of transferring money and/or other financial transactions. In order to obtain broad global coverage, such private businesses have had to establish a wide network of financial sites. As such, there is a huge overhead associated with the payment of salaries and maintenance of the infrastructure. Consequently, these costs are passed on to the customers who are charged high commission rates for the transactions as well as significantly higher exchange rates. And because other viable methods for handling such monetary transfers are severely limited, senders and receivers have no choice but to pay these inflated fees.

Other methods for transferring money involve sending personal checks or currency through the mail. Sending personal checks is slow due to the dependency on the postal system. More significantly, banks will not cash a personal check until they can verify both the availability of the funds and the identity of the receiver. Banks usually charge fees for cashing these checks. Again, there is the requirement for a financial institution to be available at the receiver's location, which is not always the case in small, rural, or remote communities. Likewise, mailing currency in an envelope, using the postal system, is not only slow, but carries a high risk of theft. Alternatively, one could send the personal check or cash via a courier. However, this option is expensive and labor intensive. It requires planning far in advance so as to synchronize the transaction with that of the courier.

Accordingly, what is needed is an apparatus and method that can facilitate the safe, rapid and economical transfer of money from a sender to a geographically distant receiver. It would be preferable if such an apparatus and method had the capability of tracking the transaction along its route. The present invention provides a novel solution to the above needs.

### DISCLOSURE OF THE INVENTION

The present invention covers an apparatus and method which provides a fast, safe, and economical way for transferring money from a sender to a geographically distant receiver. Initially, the sender gives the money to his or her choice of one of a number of nearby independent sender agents. The sender agent notifies an independent receiver agent which is situated close to the receiver. The notification is sent over a network, such as the Internet, and instructs the receiver agent as to the identity of the sender, the amount of money to be transferred, and to whom the money is to be given. It is the responsibility of the receiver agent to contact and disburse the money to the receiver.

In one embodiment, an intermediary is used to act as a financial clearing house. It is the responsibility of the intermediary to track, clear, and guarantee secure financial transactions. Optionally, the intermediary can also maintain a list of registered sender agents and receiver agents.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 shows a block diagram, which illustrates the prior art business model whereby the sender and receiver are reliant upon a single entity as a financial intermediary.

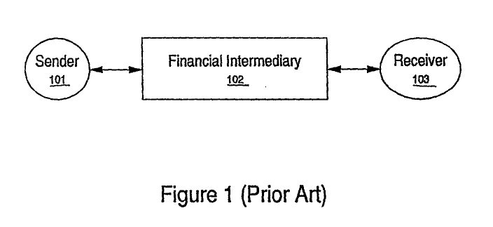

FIG. 2 shows a block diagram illustrating an exemplary network of communicatively coupled devices upon which embodiments of the present invention may be practiced.

FIG. 3 shows a block diagram illustrating the transaction process utilizing sender and receiver agents with an intermediary affecting the moving of funds.

FIG. 4 is a flow diagram illustrating the flow of the transaction in accordance with one embodiment of the present invention.

FIG. 5 illustrates further detail of the fundamental architecture for the money transfer process in accordance with one embodiment of the present invention.

### BEST MODE FOR CARRYING OUT THE INVENTION

In the following detailed description of the present invention, numerous specific details are set forth in order to provide a thorough understanding of the present invention. However, it will be obvious to one skilled in the art that the present invention may be practiced without these specific details or by using alternate elements or methods. In other instances well known methods, procedures, components, and circuits have not been described in detail as not to unnecessarily obscure aspects of the present invention.

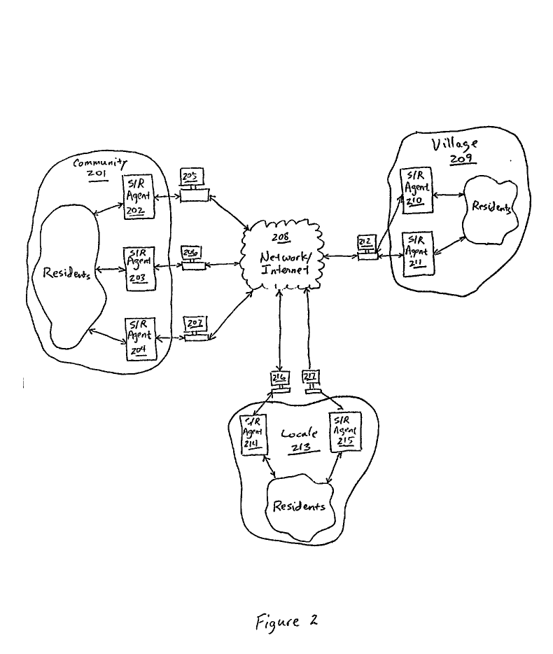

FIG. 2 shows a block diagram of an exemplary network upon which embodiments of the present invention can be implemented. Groups of people residing within a common geographical location can be characterized as belonging to a community 201, village 209, or locale 213. A community 201 has access to one or more sender and/or receiver (S/R) agents 202-204. These agents are people generally known, well-regarded, and trusted by the people in that community. Agents may be affiliated with, for example, a religious organization, a community club, a professional society, or a hometown association. They are reputable and hold themselves out to the community 201 for handling their financial transactions. These agents are independent from the traditional financial and banking institutions. The agents may serve in an agent capacity to help out the community or to earn some additional income. And because the independent agents reside in the community in which they serve, their overhead is kept to a minimum. The environment in which this invention will work best is that of a small community or village in which the residents know each other well and have strong personal trust and relationships. In this environment the risk of fraud is minimized and the transmission and delivery of money can become a part of the social interaction of the community.

As such, an individual within a community 201 can select one of the agents 202-204 belonging to that particular community for sending money. Likewise, money being sent to someone in community 201 from a distant sender may be disbursed by one of the agents 202-204 to the designated receiver. These agents 202-204 have access to a personal computer, laptop, server, personal digital assistant, wireless device, or other standard communications device 205-207 for transmitting and receiving data via the network/Internet 208. The price for purchasing and operating the hardware is becoming less expensive, thereby minimizing the costs associated with performing agent services.

Similarly, a village 209 at a geographically distant location can have its own set of independent S/R agents. It should be noted that an agent need not have his or her own dedicated communications device. For example, agent 210 and agent 211 can share access to a single personal computer 212. In principle, each different locale can have one or more independent agents. For instance, locale 213 may have agents 214 and 215. These agents are used by the residents living or working within or in close proximity to that particular locale for the purposes of sending or receiving money transfers. The agents each have access to a communications device. It is through the communications devices that the respective agents transmit and receive instructions regarding particular money transfers via network/Internet 208.

Network/Internet 208 may represent a portion of a communication network located within a firewall of an organization, corporation or financial institution (an “Intranet”), or network 208 may represent a portion of the World Wide Web or Internet. The mechanisms for coupling computer systems or other similar communications devices over the Internet (or Intranet) 208 are well known in the art. In the present embodiment, standard Internet protocols like IP (Internet Protocol), TCP (Transmission Control Protocol), HTTP (HyperText Transfer Protocol) and SSL (Secure Sockets Layer) are used to transport data between clients and servers, in either direction. However, the coupling of computer systems can be accomplished over any network protocol that supports a network connection, including NetBIOS, IPX (Internet Packet Exchange), and LU6.2, and link layers protocols such as Ethernet, token ring, and ATM (Asynchronous Transfer Mode). Computer systems may also be coupled via their respective input/output ports (e.g., serial ports) or via wireless connections (e.g., according to IEEE 802.11b).

By utilizing the present invention, anyone having access to an agent can send money to someone who has access to an agent. For example, an individual in community 201 can select Sender Agent 203 for the transfer of money to a designated receiver in village 209. The sender gives the money to Sender Agent 203. Thereupon, Sender Agent 203 transmits instructions over network/Internet 208 to receiver agent 210 regarding the money transfer. The receiver agent contacts the receiver who then comes to the agent and collects the money. The transfer of money between agents can be handled through traditional financial and banking mechanisms. The agents can arrange to aggregate and settle their various transfers through one transaction. Furthermore, the agents, as opposed to the senders and receivers, are better suited to dealing with financial transactions. It is appreciated that the present invention can be utilized with any number of computer/communications devices. Furthermore, these devices can be physically situated at different locations. One can use this system to transfer funds across town or even internationally with equal ease.

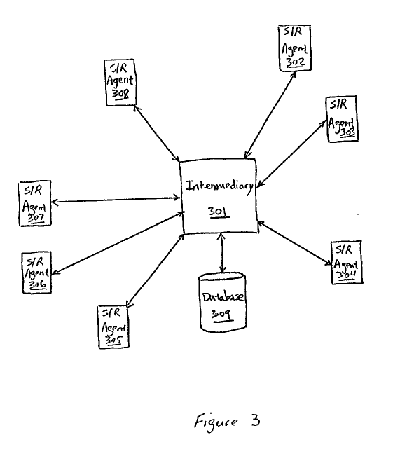

In one embodiment of the present invention, an intermediary is used to facilitate the transfers of money between agents. FIG. 3 shows a block diagram of an exemplary intermediary 301 used to facilitate money transfers between various sender and receiver agents 302-308. In this embodiment, the present invention entails the use, by the sender of funds, of an independent Sender Agent and the use, by the receiver, of an independent receiver agent working through an intermediary 301 whose responsibilities encompass acting as a Tracking System, Clearing/Auction House and Guarantor of secure transactions. The intermediary can have a web site which shows the state of any particular money transaction. A money transaction can be assigned a tracking number. As soon as an agent makes a disposition on a money transaction, notification of the disposition can be sent to the intermediary. At this point, the intermediary updates and displays the current status of that particular transaction. In this manner, senders, sender agents, receiver agents, and receivers can track the progress and status of any particular money transaction.

The intermediary can also guarantee the transaction. This can be done by utilizing secure communications, resolving disputes, fixing errors, and acting as an insurance agency. Furthermore, the intermediary serves as a financial clearinghouse. It obtains and makes available lists of financial institutions for transferring the funds. This list can be maintained in the form of a searchable database. The intermediary would also be responsible for maintaining a list of registered agents for senders and receivers who do not have known and trusted individuals already available for such roles. This list can include relevant information pertaining to the agents such as number of complaints, number of years of operation, customer feedback, etc. Likewise, this list of agents and relevant information can be stored and accessed as a hierarchical, searchable database 309 or similar archive. Furthermore, the intermediary can serve as an auction site where exchange rates and the lowest prices at which agents are willing to transfer funds between senders and receivers are put up for bid. This competitive bidding, given appropriate Information Technology and Telecommunications infrastructure, will reduce the overall transaction cost so that a larger percentage of the money reaches the intended receiver. The incentives for the private individuals to participate include both the profit motive and a sociological motive for improving the standard of living in their community at little or no cost to themselves.

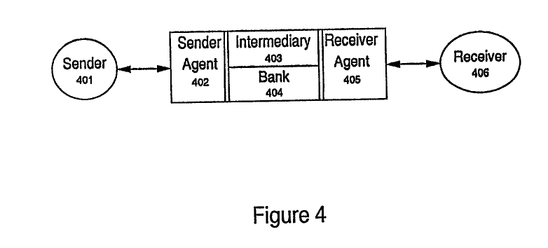

FIG. 4 is a flow diagram illustrating the flow of the transaction in accordance with one embodiment of the present invention. This illustrates the partitioning of the intermediary into Sender Agent 402, Intermediary 403, Bank 404 and Receiver Agent 405. This clearly demonstrates one of the novel aspects of the present invention over the prior art. In this embodiment, the present invention focuses on the end to end principals of the money transfer market. The Sender 401 is the individual who is sending the money to a receiver 406 in another country. To accomplish this transaction, the Sender 401 might go to a Sender Agent 402. This Sender Agent 402 would utilize an Intermediary 403 who would function as a clearing house and auction house for the Agents, utilizing a computer and Internet as described in FIGS. 2 and 3, to obtain a Receiver Agent 405 and a Bank 404 to transfer the funds to the Receiver Agent 405. The Receiver Agent 405, in turn, would deliver the funds to the Receiver 406. Sender Agent 402 and Receiver Agent 405 are empowered private individuals. They will bid on the best exchange range and the lowest price at which they are willing to transfer funds between Senders and receivers, and in time may choose to do it full time as a business.

In FIG. 4, the Bank 404 would be the medium of transfer of the funds and may be utilized through an ATM (Automated Teller Machine) Card, by Cash, by a Smart Card or some other form of a prepaid card, or over the Internet or by an anonymous card based on numerical codes known to the receiver, similar to prepaid telephone cards, which can be accessed by the receiver presenting the card along with the code. Another possible access to Bank 404 would be a credit at a store or other financial institution. The Intermediary 403 of FIG. 4 would exist as a web page on the Internet. The communications from Sender Agent 402 to Receiver Agent 405 would be through secure connections and encryption. The Intermediary 403 tracks the transfer process, registers Sender Agent 402 and Receiver Agent 405 and makes a list of said agents available, and provides a medium through which bidding for lowest cost transactions can take place, utilizing a web site on the Internet.

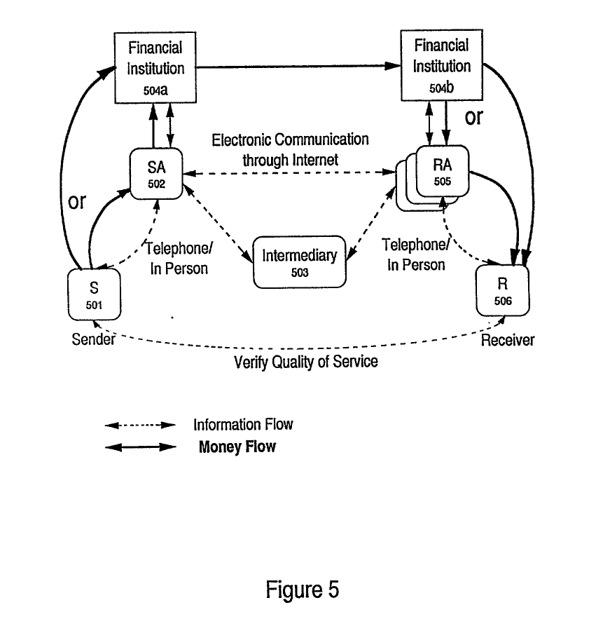

FIG. 5 illustrates further details of one fundamental architecture for the money transfer process in accordance with one embodiment of the present invention. The Parties in the transaction include: (1) S, the Sender (the person sending the money); (2) SA, the Sender's Agent who access to the Internet and the Intermediary's infrastructure; (3) RA, the Receiver Agent who is a trusted individual with banking abilities and access to the Internet; (4) an Intermediary who guarantees that the SA and RA will perform according to their contracts; (5) Banks which transfer funds and money from one entity to another; and (6) the Receiver who knows and trusts the RA and is the individual ultimately receiving the money.

There exist certain underlying assurances in the process illustrated in FIG. 5 which serve to facilitate the money remittance system. One assurance is that the Sender, S, in step 501 and receiver, R, in step 506 know each other well and possibly have a personal relationship. Another assurance is that the Receiver Agent, RA, in step 505 is trusted by the Receiver in step 506 and might actually be located in the same geographical area as the Receiver. Yet another assurance is that the Sender in step 501 and Sender's Agent in step 502 may be the same person. Likewise, the Receiver in step 506 and Receiver Agent in step 505 may be the same person. Moreover, the Sender's Agent and Receiver Agent may be related (e.g., friends, family members, etc.). However, all contracts and agreements must conform to standards set up by the Intermediary if they choose to go through the Intermediary. There is nothing to prevent the RA and SA from communicating directly by phone or by e-mail if they so choose, in which case, the transaction will not be guaranteed by the Intermediary.

Next, the Sender in step 501 goes to Sender Agent in step 502 and requests a quote for transmitting funds to the receiver in step 506. The Sender provides the Receiver's name, address, phone number, or other contact information as necessary. The Sender Agent finds a suitable Receiver Agent in step 505 willing to provide the service. Optionally, the Sender might solicit bids from different receiver agents. The Sender Agent in step 502 may use the Internet to access the market in the local area of the receiver and receive bids over the Internet. In the event that the Sender knows a reputable Receiver Agent, the Sender Agent in step 502 may send an Email directly to the Receiver Agent. The Sender Agent quotes the total transaction cost after checking with the network/Market through the Intermediary's web site in step 503. If the terms are agreeable, the Sender accepts and confirms the offer with Sender Agent and hands over the money to the Sender Agent.

The Sender Agent then contacts the Intermediary of step 503 and/or Receiver Agent of step 505 to communicate that funds have been received by the Sender Agent. The Sender Agent also notifies the Receiver agent that the funds are being deposited with his or her financial institution in step 504a. In this manner, the Receiver Agent knows that funds will be available at his or her financial institution in step 504b under the guarantee of the Intermediary in step 503. The Receiver Agent then contacts the Receiver who knows and trusts the Receiver Agent. The Receiver Agent makes the requisite arrangements for the funds to be transferred to the receiver in the form of cash or credit to a third party. The receiver in step 506 acknowledges receipt of the money or credit. The Receiver Agent of step 505 transmits acknowledgment to Sender Agent of step 502. Thereupon, the Sender Agent transmits acknowledgment to the Sender. The Receiver may then communicate the quality of service to the Sender directly (without going through the Sender Agent or Receiver Agent), so that the Sender can decide whether or not to repeat business with the same Receiver Agent in the future.

The following three examples of scenarios for money transfers between people located in the United States and Mexico are offered to demonstrate various aspects of the present invention. It should be noted however, that these examples can be expanded for and within other countries:

Scenario 1 Situation:

Jose (in San Jose, Calif., U.S.) has a bank account that is ATM accessible. The ATM is on one of the large ATM networks such as Plus, Cirrus, Star, etc. If Jose does not have a bank account, members of the Intermediary and/or network of agents could help Jose to open an account.

Martha (in Nueva Italia, Michoacan, Mexico) is the spouse of Jose. Jose wants to send money periodically to Martha.

Solution:

Jose is trained to become comfortable with ATM withdrawals and to get an additional ATM card for his account.

Jose sends Martha the ATM card to access Jose's Bank Account.

Martha can withdraw money in Mexico with the ATM card when necessary.

Cost of Transaction=ATM Fee+exchange rate fee.

Roles:

Jose plays the role of both S and SA.

Martha plays the role of both R and RA.

No Intermediary is involved.

Only one Bank is involved.

To enable this scenario, the whole process is properly documented and communicated to money-sending communities in the U.S. and money-receiving communities in Mexico through Radio and TV advertisement campaigns, Mexican Consulate, local Mexican organizations such as MEXPRO, and Mexican businesses in the U.S.

Scenario 2 Situation:

Marcos is the cousin of Jose. Marcos does not have a bank account.

Graciela is the wife of Marcos. Graciela lives 3 blocks from Martha. Marcos wants to send money periodically to Graciela.

Solution:

Marcos gives the money to Jose who deposits it into his account.

He then informs Martha to draw the money and give it to Graciela.

Martha uses the ATM card to withdraw the money and gives it to Graciela on the next visit to her.

Cost of Transaction=ATM Fee+exchange rate fee.

Roles:

Marcos plays the role of S.

Jose plays the role of SA.

No Intermediary is involved.

Only one Bank is involved.

Martha plays the role of RA.

Graciela plays the role of R.

Scenario 3 Situation:

Pedro is Graciela's brother. He works in the construction industry in San Jose, Calif., and knows and trusts Jose.

Pedro periodically sends money to his mother.

Pedro's mother lives with Jesus, Pedrois sibling, 25 Kilometers from Martha.

Jesus has a Mexican bank account.

Pedro does not have a US bank account.

Jesus does not know Martha directly, but only indirectly through Graciela.

Solution:

Martha opens a bank account at the local branch of the bank where Jesus banks.

Pedro gives the money to Jose who deposits it in his bank account.

Pedro informs his mother that the money is on the way.

Jose instructs his wife to send the money to Jesus.

Martha withdraws the money from the ATM, deposits it in her bank account, and then issues a check to Jesus or gets the money to him through the bank.

Cost of Transaction=ATM fee plus whatever bank charges in the Mexican bank exchange rate fee.

Roles:

Pedro plays the role of S.

Jose plays the role of SA.

Martha plays the role of RA in one transaction and SA in another transaction.

While no Intermediary is involved, Pedro may be loosely considered the Intermediary by our definition.

Jesus plays the RA.

Jesus' mother plays the role of R.

Two Banks are involved in the transaction.

In summary, embodiments of the present invention provide a method and system for transferring funds between individuals residing in different locations so as to minimize the cost of such transactions. The Sender and Receiver can reside within the same country or can reside in different countries. As such, present invention can be used to facilitate domestic as well as international monetary transactions. Therefore, the preferred embodiment of the present invention, an apparatus and method which provides a fast, safe, and economical way for transferring money from a sender to a geographically distant receiver has been disclosed.

What is claimed is:

1. A method for transferring money from a sender to a receiver at a location different from the sender comprising:
selecting a sender agent from a plurality of independent sender agents listed in a database;
selecting a receiver agent from a plurality of independent receiver agents listed in the database;
authorizing the sender agent to transfer the money to the receiver agent, wherein the authorization is transmitted over a data network;
sending information pertaining to the transfer of the money over the data network;
transferring the money from the sender agent to the receiver agent through a financial network, wherein the receiver agent gives the money to the receiver upon receiving the money from the financial network and wherein the sender agent and the receiver agent are independent of the financial network.

2. The method of claim 1 further comprising the step of using an intermediary to facilitate the transfer of money between the sender agent and the receiver agent.

3. The method of claim 1, wherein the intermediary hosts a web site which lists the plurality of independent sender agents and the plurality of independent receiver agents.

4. The method of claim 1, wherein the intermediary tracks the transfer of the money.

5. The method of claim 1 further comprising the step of the intermediary serving as a financial clearing house with respect to the plurality of independent sender agents and receiver agents.

6. The method of claim 1 further comprising the step of the intermediary guaranteeing financial transactions between the sender, the selected sender agent, and the selected receiver agent.

7. The method of claim 1 further comprising the step of bidding for services rendered by the plurality of sender agents and receiver agents.

8. The method of claim 1 further comprising the steps of grouping a plurality of money transfers and sending the money in one financial transaction.

9. A money remittance system, comprising:
a plurality of sender agents, wherein each of the sender agents is an independent business entity;
a plurality receiver agents, wherein each of the receiver agents is an independent business entity;
a communications network coupling the plurality of sender agents with the plurality of receiver agents, wherein a sender gives money to one of the sender agents, the money is transferred by one of the sender agents to one of the receiver agents via a financial transaction, and the money is given to a receiver designated by the sender and conveyed over the communications network which is different than a medium used to effectuate the financial transaction.

10. The money remittance system of claim 9 further comprising an intermediary having a web site which lists the plurality of sender agents and the plurality of receiver agents.

11. The money remittance system of claim 9, wherein the intermediary serves as a financial clearing house with respect to the plurality of independent sender agents and receiver agents.

12. The money remittance system of claim 9, wherein the intermediary guarantees financial transactions between senders, the sender agents, and the receiver agents.

13. The money remittance system of claim 9, wherein the intermediary auctions services offered by the plurality of sender agents and receiver agents.

14. The money remittance system of claim 9, wherein a plurality of money remittances from a plurality of senders are grouped together and transferred in one single financial transaction which is then disbursed to a plurality of receivers.

15. The money remittance system of claim 9, wherein the money is transferred across an international boundary.

16. The money remittance system of claim 9, wherein the financial transaction comprises an automatic teller machine transfer.

17. A method for transferring money from a sender to a receiver, comprising:
selecting a particular sender agent from a plurality of independent sender agents;
selecting a particular receiver agent from a plurality of independent receiver agents;
authorizing a selected sender agent to transfer the money to a receiver agent;
transferring the money from the selected sender agent to the selected receiver agent through a financial transaction medium; and
sending information pertaining to the money transfer over a network.

18. The method of claim 17 further comprising the step of disbursing the money at one of a bank automatic teller machine, a gas station, or a convenience store.

19. The method of claim 17 further comprising the step of handling the financial transaction by a single banking institution having multiple branches in different geographical locations corresponding to the selected sender agent and selected receiver agent.

20. A method of facilitating a money transfer between a sender and a receiver located at a distance away from the sender by an intermediary, comprising:
listing information pertaining to a plurality of agents on a web site;
accepting a selection by the sender for one of the agents to become a sender agent;
accepting a selection by the sender for one of the agents to become a receiver agent;
transferring the money from the sender agent to the receiver agent by a first medium used to handle financial transactions;
aiding in transmission of information pertaining to the financial transaction by a second medium used to transmit data.

21. The method of claim 20 further comprising the step of tracking the money transfer.

22. The method of claim 20 further comprising the step of securing the transmission of information.

23. The method of claim 20 further comprising the step of providing a competitive bidding process for services offered by the plurality of agents.
